(19) United States
(12) Patent Application Publication
(10) Pub. No.: US 2014/0374434 A1
(43) Pub. Date: Dec. 25, 2014

(54) Notepaper Dispensing Box

(71) Applicant: David C.T. Jour, Taipei (TW)

(72) Inventor: David C.T. Jour, Taipei (TW)

(21) Appl. No.: 13/921,451

(22) Filed: Jun. 19, 2013

(51) Int. Cl. B65D 83/08; B42D 5/00

(52) U.S. Cl. CPC B65D 83/0817; B42D 5/005
USPC 221/59

(57) ABSTRACT

A notepaper dispensing box as claimed in box, which comprising: a box body and a base plate; an opening for output of the removable notepaper is set on the upper surface of the box body, and an elongated notch is set separately at both short sides to output removable notepaper of various types and dimensions; the box body and base plate are interlocked by the hooks and slots; a card case is set separately at both long sides of the box body for holding the business cards, and multiple partitions are embedded to limit the shift of the removable notepaper; an elastic body is supported between the removable notepaper and the base plate, such that the removable notepaper is lifted automatically to the opening after it is consumed; a rubber sucking disk is adhered onto the base plate, allowing for backward thrust when touching the box body at any direction; and the box body can be attached onto any table surface with non-slip effect.

### BACKGROUND OF INVENTION

1. Field of the Invention

The present invention relates generally to a notepaper box, and more particularly to a dispensable one which allows to add the notepaper automatically and repetitively with a removable locking structure and a sucking disk for fixation on the holder body.

2. Description of Related Art

Notepaper is commonly used for recording important matters, memo items and common concerns. Generally, the notepaper is overlapped by multi-layer of paper sheets, and adhesive is applied onto the bottom flange of paper sheets at the same side in the form of books; in practice, important matters are recorded on the surface of a piece of notepaper, which is then adhered temporarily at any position for reminding purpose. Hence, the users could, depending on their own demands and preference, select removable notepaper of various dimensions, and add automatically for repetitive use and extending the service life.

Such advantages of notepaper are welcomed by many users, however, it is found during applications that: the notepaper is easily accessed by the users but cannot be separated smoothly due to extremely small lightweight; while pressing it by one hand, it has to be torn off by the other hand, making it difficult for convenient use and separation, especially when only a few paper sheets are kept; if the notepaper box is placed on the glass table surface, the box body is vulnerable to slippage, making it difficult for extraction; furthermore, owing to the limited quantity, such notepaper of shorter service life has to be purchased regularly, bringing about inconvenience for the users.

Thus, to overcome the aforementioned problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### CONTENT OF INVENTION

The primary objective of the present invention is to provide a notepaper dispensing box that can be filled with various types of removable notepaper and disassembled easily for adding the removable notepaper for extended service life and repetitive use.

Another objective of the present invention is to provide a removable notepaper box that can be placed on the glass table surface with non-slip effect.

The present invention provides a notepaper dispensing box, which comprises: a box body and a base plate; an opening for output of the removable notepaper is set on the upper surface of the box body, and an elongated notch is set separately at both short sides to output removable notepaper of various types and dimensions; the box body and the base plate are enclosed by hooks and slots; a card case is set separately at both long sides of the box body for holding the business cards, and multiple partitions are embedded to limit the slippage of the removable notepaper; an elastic body, which can be supported between the removable notepaper and the base plate, such that the removable notepaper is lifted automatically to the opening after it is consumed; a rubber sucking disk is adhered onto the base plate, allowing for backward thrust when touching the box body at any direction; and the box body can be attached onto any table surface with non-slip effect.

Furthermore, the box body is provided with a longitudinal partition and a transverse partition to enclose the removable notepaper against slippage.

Furthermore, the base plate is locked onto one surface of the box body in such a way that the base plate is embedded into the hooks of the box body by the slots at four corners, and slidably abutted into the trips on the slots of the base plate; or the base plate is disengaged by slightly pushing it away.

Furthermore, the box body and base plate are transparent, so the filled removable notepaper showcases colorful effect, and the embedded ads cards could attract the attention of people.

The structural features and efficacies of the present invention will be more readily understood upon a thoughtful deliberation of the following detailed description of the preferred embodiment with reference to the accompanying drawings:

### BRIEF DESCRIPTION OF THE DRAWINGS

FIG. 1: an exploded perspective view of the present invention.

FIG. 2: an assembled view of the present invention.

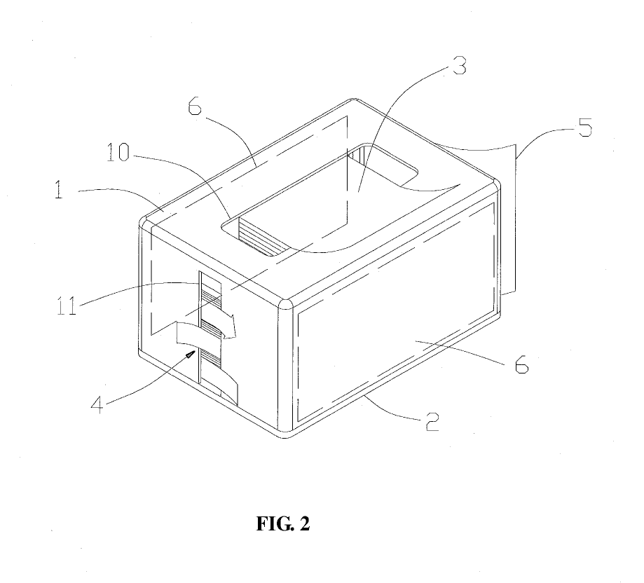

FIG. 3: a sectional view of the assembly part of the present invention.

FIG. 4: a schematic view of the present invention that a removable notepaper is embedded.

FIG. 5: a schematic view of the present invention that a rubber sucking disk is fixed on the glass table surface.

FIG. 6: a schematic view of the present invention that elongated removable notepaper is embedded.

### DETAILED DESCRIPTION OF THE INVENTION

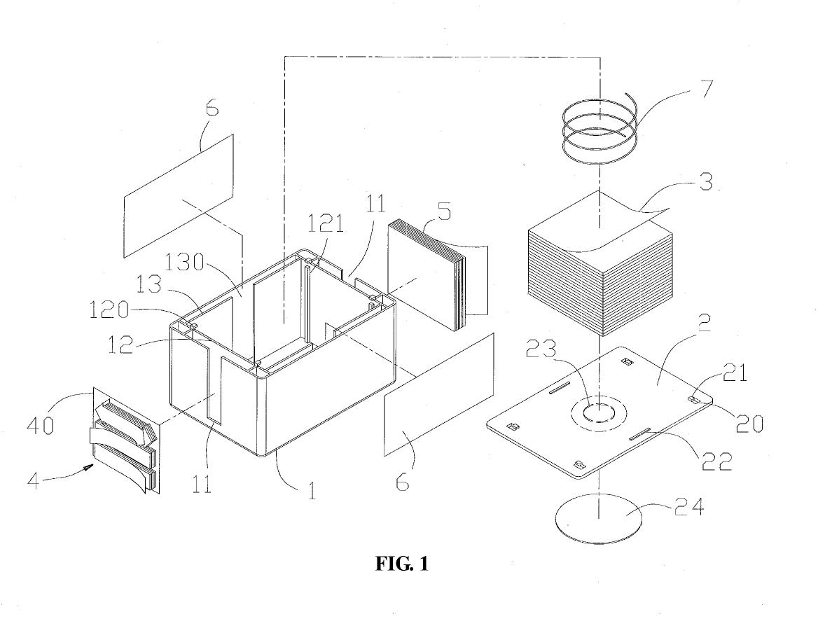

Referring to FIGS. 1˜5, the “notepaper dispensing box” of the present invention comprising: a box body 1 and a base plate 2;

the box body 1 is of a hollow casing with an opening pattern onto one surface; an opening 10 for output of the removable notepaper 3 is set on the upper surface of the box body 1, and an elongated notch 11 is set separately at both short sides to output removable notepaper of various types and dimensions; multiple partitions are set into the box body 1; a longitudinal partition 12 is set opposite to both short sides, so as to separate spaces for accommodating the removable notepaper; of which, a removable notepaper set 4 is accommodated into a short side; the elongated removable notepaper set 4 composed of square, pointed and arrow shapes is attached onto a sheet 40, whilst another square removable notepaper set 5 is set at the other opposite surface; a transverse partition 13 is separately set within both long sides of the box body 1, so as to separate spaces for accommodating business cards 6; the removable notepaper 3 is accommodated into the space enclosed by the longitudinal partition 12 and transverse partition 13 for limitation of slippage; a hook 120 and a column 121 are separately set onto the longitudinal partition 12 close to four corners; a notch 130 is set at center of the transverse partition 13 for fetching the business cards 6;

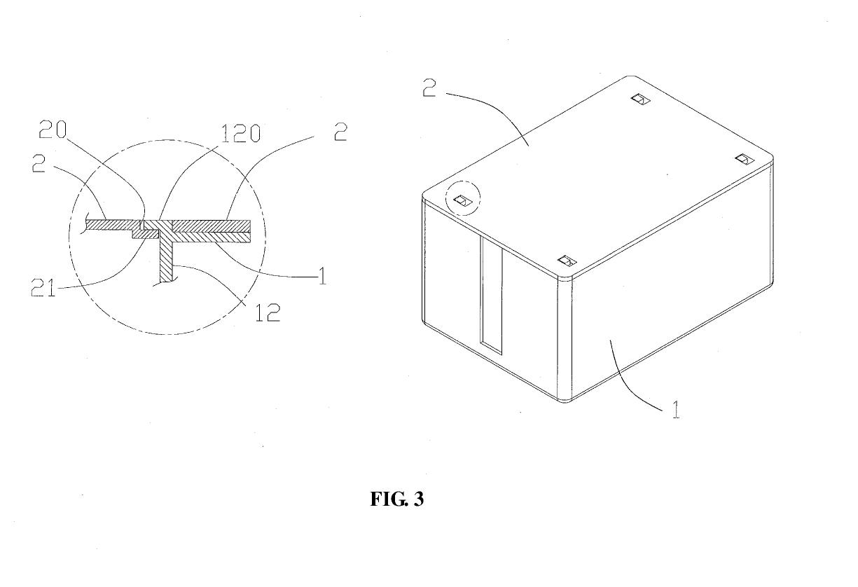

the base plate 2 is sealed into the opening 10 at one surface of the box body 1; a slot 20 is separately set close to four corners of the base plate 2; the slot 20 is provided with a trip 21, and the base plate 2 is provided with an elastic body 7, which is supported between the removable notepaper 3 and base plate 2; a bulge 22 is separately set on the long sides of the removable notepaper 3 and base plate 2, correspondingly to the notch 130 of the transverse partition 13 of the box body 1, then filled into the notch 130 of the transverse partition 13 and supported below the business cards 6 to avoid inclination when single business card 6 is used; a shallow groove 23 is set at bottom center of the base plate 2, and a rubber sucking disk 24 of slightly recessed pattern is adhered onto the bottom of the base plate 2, as shown in FIG. 3.

Referring to FIG. 3, when the box body 1 and base plate 2 are assembled, slots 20 at four corners of the base plate 2 are used to be embedded into the hooks 120 of the box body 1, allowing for slidable locking between the slot 20 and trip 21 of the base plate 2; or the base plate 2 is disengaged by slightly pushing it away.

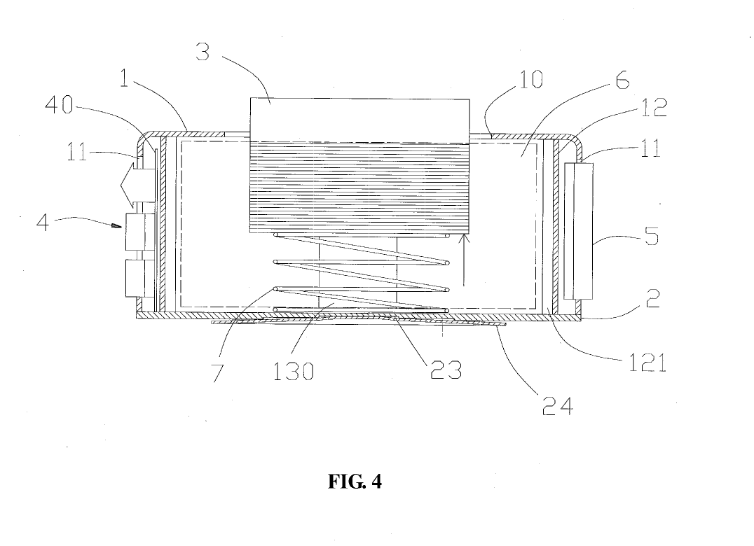

Referring to FIG. 4, when fetching the removable notepaper 3, the removable notepaper 3 on the elastic body 7 will gradually release elastic force, which supports upwards to lift and output continuously the removable notepaper 3 from the opening 10, preventing the removable notepaper 3 from falling into the opening 10 of the box body 1 due to decreasing quantity.

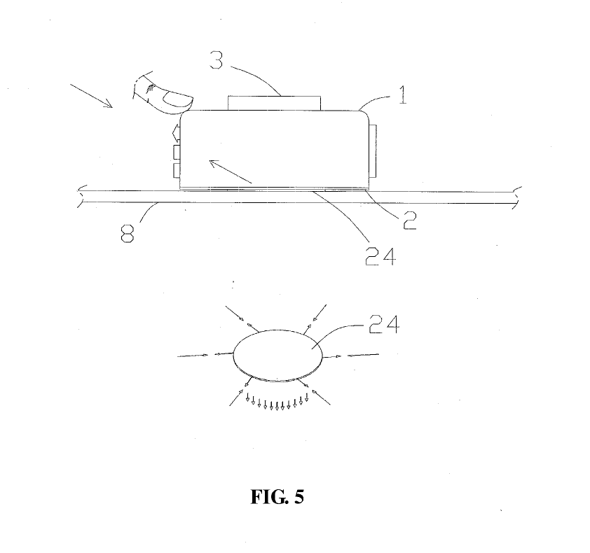

Referring to FIG. 5, the rubber sucking disk 24 is adhered onto the bottom of the base plate 2, allowing for backward thrust when touching the box body 1 at any direction; and air in the rubber sucking disk 24 is extruded at the same time, such that the rubber sucking disk 24 has a stronger adhesion on the contact surface, and the box body 1 could be adhered securely onto the table or even slippery glass table surface 8.

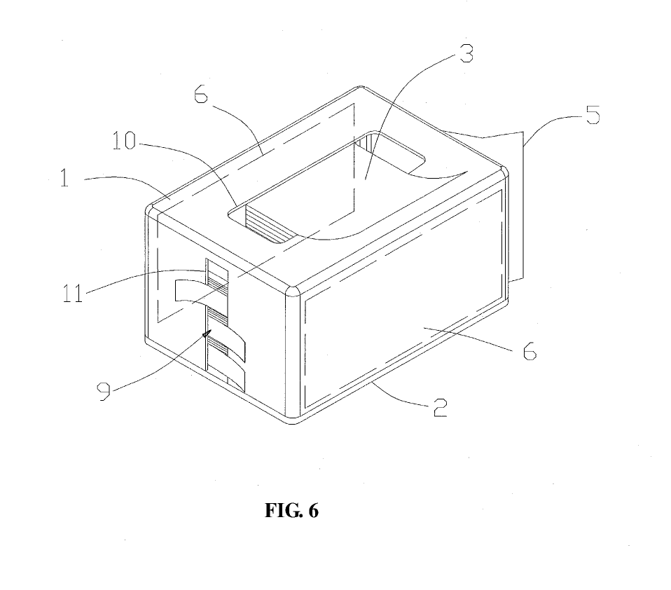

Referring to FIG. 6, the elongated removable notepaper set 4 attached on a sheet 40 could be supplemented or replaced by a single sheet or a complete set of removable notepaper, e.g.: three elongated removable notepaper sets 9 of flat ends are replaced.

To sum up, the present invention is fitted with three removable notepaper sets of various types and dimensions, which are made of materials of any color for identification or waterproofing; the box body and base plate are transparent, so the filled removable notepaper showcases colorful effect, of which the removable notepaper set is composed of three types of elongated removable notepaper, especially removable notepaper of arrow pattern with a waterproofing adhesive film; both ends of the removable notepaper are provided with indicating arrows, such as semi-transparent adhesive arrow at one end and transparent adhesive arrow at the other end; of which the semi-transparent adhesive arrow is coated with weak adhesive on the colored surface, allowing for overlapping and connection in a staggered way; so the notepaper could be extracted successively, and users can record something onto the colored surface. The present invention provides a card case, which is a transparent casing that allows to accommodate business cards and clearly watch them for ads effect.

The present invention has innovative technical thoughts of industrial benefits and inventiveness, so the claims are made hereinafter.

Although the invention has been explained in relation to its preferred embodiment, it is to be understood that many other possible modifications and variations can be made without departing from the spirit and scope of the invention as hereinafter claimed.

1. A notepaper dispensing box, which comprising: a box body and a base plate, of which the box body is of a hollow casing with an opening onto one surface; an opening for output of the removable notepaper is set on the upper surface of the box body, and an elongated notch is set separately at both short sides to output removable notepaper of various types; a space for accommodating business cards is set separately at both long sides of the box body, and multiple partitions are set to limit the slippage of the removable notepaper; an elastic body is supported between the removable notepaper and the base plate, such that the removable notepaper is lifted automatically to the opening after it is consumed; a slot is separately set at four corners of the base plate, and provided with a trip; the base plate is embedded into the hooks on the partitions of the box body by the slots, and the base plate slides in a way that the trips and hooks are interlocked, so the base plate could seal the box body.

2. The notepaper dispensing box as claimed in claim 1, wherein spaces for accommodating business cards are segregated by partitions at both long sides of the box body, and a notch is set at center of the partition for fetching the cards, and a bulge is set on the surface correspondingly to the base plate.

3. The notepaper dispensing box as claimed in claim 1, wherein a shallow groove is set at bottom of the base plate, and a rubber sucking disk is adhered.
